(19) United States
(12) Patent Application Publication
(10) Pub. No.: US 2024/0354969 A1
(43) Pub. Date: Oct. 24, 2024

(54) EFFICIENT MOTION ESTIMATION IN AN IMAGE PROCESSING DEVICE

(71) Applicant: QUALCOMM Incorporated, San Diego, CA (US)

(72) Inventors: Chanchal Raj, Bangalore (IN); Mayank Mishra, Kanpur (IN); Pradeep Veeramalla, Hyderabad (IN); Sandeep Ramisetty, Hyderabad (IN)

(21) Appl. No.: 18/304,549

(22) Filed: Apr. 21, 2023

(51) Int. Cl. G06T 7/262; G06T 7/13; G06T 7/246; G06V 10/70

(52) U.S. Cl. CPC G06T 7/262; G06T 7/13; G06T 7/248; G06V 10/70; G06T 2207/10016; G06T 2207/20048

(57) ABSTRACT

This disclosure provides systems, methods, and devices for image signal processing that support efficient motion estimation. In a first aspect, a method of image processing includes determining first and second sets of correlation parameters for respective first and second frames, generating a transform matrix indicating motion from the first frame to the second frame in accordance with the correlation parameters, and inverting the transform matrix to produce an inverted transform matrix. Other aspects and features are also claimed and described.

### TECHNICAL FIELD

Aspects of the present disclosure relate generally to image processing, and more particularly, to motion estimation. Some features may enable and provide improved image processing, including improved motion estimation transform matrix generation in image processing.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The amount of image data captured by an image sensor has increased through subsequent generations of image capture devices. The amount of information captured by an image sensor is related to a number of pixels in an image sensor of the image capture device, which may be measured as a number of megapixels indicating the number of millions of sensors in the image sensor. For example, a 12-megapixel image sensor has 12 million pixels. Higher megapixel values generally represent higher resolution images that are more desirable for viewing by the user.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power proportional to the amount of image data, or number of megapixels, in the image capture. The additional power consumption may shorten the operating time of an image capture device using battery power, such as a mobile phone.

Dynamic range may be important to image quality when capturing a representation of a scene with a wide color gamut using an image capture device. Conventional image sensors have a limited dynamic range, which may be smaller than the dynamic range of human eyes. Dynamic range may refer to the light range between bright portions of an image and dark portions of an image. A conventional image sensor may increase an exposure time to improve detail in dark portions of an image at the expense of saturating bright portions of an image. Alternatively, a conventional image sensor may decrease an exposure time to improve detail in bright portions of an image at the expense of losing detail in dark portions of the image. Thus, image capture devices conventionally balance conflicting desires, preserving detail in bright portions or dark portions of an image, by adjusting exposure time. High dynamic range (HDR) photography improves photography using these conventional image sensors by combining multiple recorded representations of a scene from the image sensor.

Movement of subjects while capturing image frames (i.e., image frames for composition into a single still image, image frames for use as part of a video sequence) can create various distortions within the image frames. For example, movement of one or more objects within an image frame may cause the objects to blur and/or blend together or may leave motion artifacts within the captured image frame.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, a transform matrix for a second frame indicating motion from a first frame to the second frame may be inverted to produce an inverted transform matrix indicating motion from the second frame to the first frame. For example, the transform matrix may be generated using cross-correlation parameters determined in accordance with correlation parameters previously determined for the first frame, correlation parameters determined for the second frame, and objects detected in the first frame. Thus, correlation parameters determined for the first frame and object detection data for the first frame, which may be used in generation of a transform matrix for the first frame, may be reused for determination of a transform matrix for the second frame. The transform matrix for the second frame determined reusing the object detection and correlation parameters for the first frame, however, may require inversion to indicate a direction of movement from the second frame to the first frame.

Motion estimation may allow for enhanced image quality when an image capturing device is moved during recording of a series of image frames, such as during video recording scenarios, handheld recording with relative motion in a field of view, multi-frame high dynamic range (MFHDR) merge applications, and motion-compensated temporal filtering (MCTF) applications. Use of efficient motion estimation may include reuse of correlation parameters used to determine a transform matrix for a prior frame to determine a transform matrix for a current frame. Object detection data, such as Harris Corner detection (HCD) data, determined for a prior frame may also be reused to generate a transform matrix for a current frame. Such reuse may reduce the amount of computing capacity required for motion estimation applications, such as image stabilization, temporal noise reduction, high dynamic range (HDR), and other motion estimation applications. Reduction in an amount of computing capacity used for motion estimation may allow for motion estimation in devices with less computing capacity, reduced power consumption, and reduced memory usage. Furthermore, reductions in an amount of computing capacity used for motion estimation may reduce latency in image processing.

In one aspect of the disclosure, a method for image processing includes determining a first set of correlation parameters for a first frame of a sequence of frames, determining a second set of correlation parameters for a second frame of the sequence of frames, generating a transform matrix indicating motion from the first frame to the second frame in accordance with the first set of correlation parameters and the second set of correlation parameters, and inverting the transform matrix to produce an inverted transform matrix indicating motion from the second frame to the first frame.

In an additional aspect of the disclosure, an apparatus includes at least one processor and a memory coupled to the at least one processor. The at least one processor is configured to perform operations including determining a first set of correlation parameters for a first frame of a sequence of frames, determining a second set of correlation parameters for a second frame of the sequence of frames, generating a transform matrix indicating motion from the first frame to the second frame in accordance with the first set of correlation parameters and the second set of correlation parameters, and inverting the transform matrix to produce an inverted transform matrix indicating motion from the second frame to the first frame.

In an additional aspect of the disclosure, an apparatus includes means for determining a first set of correlation parameters for a first frame of a sequence of frames, means for determining a second set of correlation parameters for a second frame of the sequence of frames, means for generating a transform matrix indicating motion from the first frame to the second frame in accordance with the first set of correlation parameters and the second set of correlation parameters, and means for inverting the transform matrix to produce an inverted transform matrix indicating motion from the second frame to the first frame.

In an additional aspect of the disclosure, a non-transitory computer-readable medium stores instructions that, when executed by a processor, cause the processor to perform operations. The operations include determining a first set of correlation parameters for a first frame of a sequence of frames, determining a second set of correlation parameters for a second frame of the sequence of frames, generating a transform matrix indicating motion from the first frame to the second frame in accordance with the first set of correlation parameters and the second set of correlation parameters, and inverting the transform matrix to produce an inverted transform matrix indicating motion from the second frame to the first frame.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 shows a block diagram of an example process for processing image data with motion estimation according to some embodiments of the disclosure.

FIG. 4 shows a block diagram of an example process for processing image data with efficient motion estimation according to some embodiments of the disclosure.

FIG. 5 shows a flow chart of an example method for processing image data with efficient motion estimation according to some embodiments of the disclosure.

FIG. 6 shows a flow chart of an example method for processing image data with efficient motion estimation according to some embodiments of the disclosure.

FIG. 7 is a block diagram illustrating an example processor configuration for image data processing in an image capture device according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for enhanced motion estimation.

Particular implementations of the subject matter described in this disclosure may be implemented to realize one or more of the following potential advantages or benefits. In some aspects, the present disclosure provides techniques for reduced computing capacity usage when motion estimation is performed utilizing the techniques described herein. Reduced computing capacity usage may further reduce power consumption enhancing battery life of devices with image processing capabilities.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

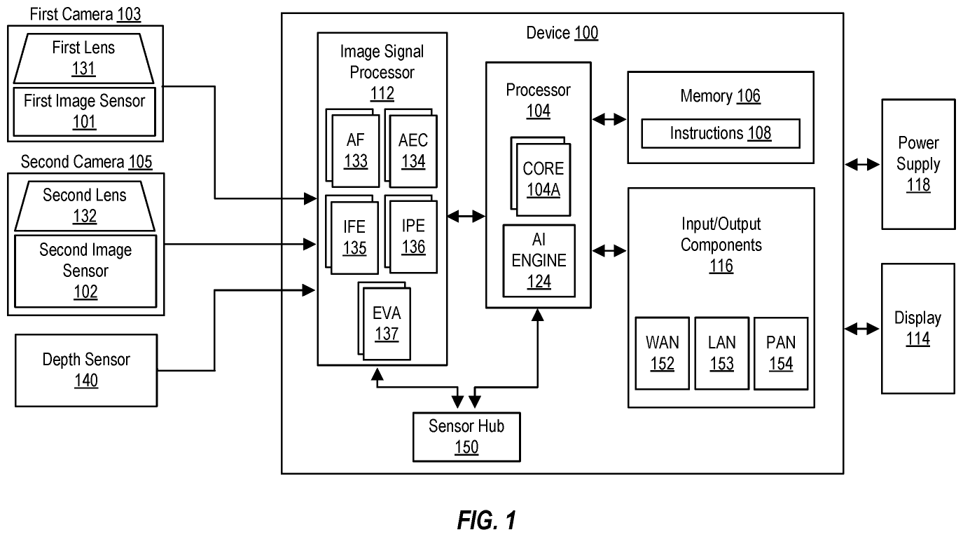

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), mmWave, and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including determining correlation parameters for one or more frames, performing object detection on one or more frames, determining a number of a frame in a sequence of frames determining a cross-correlation of two or more frames, generating a transform matrix for one or more frames, inverting a transform matrix for one or more frames, and adjusting one or more of the frames using a generated transform or inverse transform. For example, execution of the instructions can instruct the ISP 112 to begin or end capturing an image frame or a sequence of image frames, in which the capture includes correction as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of efficient motion estimation to the image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

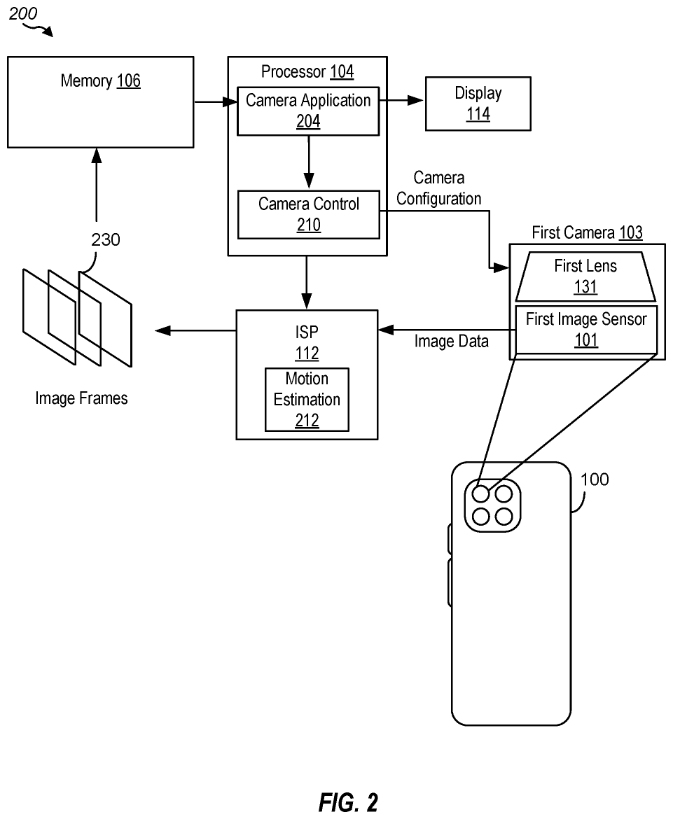

The exemplary image capture device of FIG. 1 may be operated to obtain improved images by applying efficient motion estimation. One example method of operating one or more cameras, such as first camera 103 and/or second camera 105, is shown in FIG. 2 and described below.

FIG. 2 is a block diagram illustrating an example data flow path for image data processing in an image capture device according to one or more embodiments of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, and/or high dynamic range (HDR) merging. In some embodiments, the effects may be applied in the ISP 112.

The output image frames 230 by the ISP 112 may include representations of the scene improved by aspects of this disclosure, such that motion across frames 230 may be reduced through use of image stabilization and/or temporal noise reduction techniques, frames of input image data may be combined to generate HDR frames, or image frames 230 may be otherwise enhanced using motion estimation data, such as one or more transform matrices, applied according to this disclosure. The processor 104 may display these output image frames 230 to a user, and the improvements provided by the described processing implemented in the ISP 112 and/or processor 104 improve the image quality and the user experience by enhancing image quality and/or reducing inter-frame motion. For example, motion estimation module 212 in the ISP 112 may adjust the image data received from the first camera 103 when determining the output image frames 230 according to motion estimation techniques descried herein.

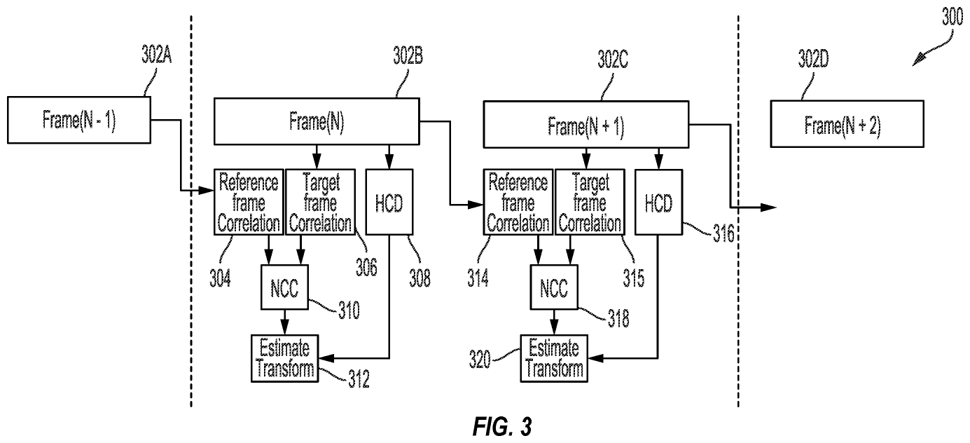

Motion estimation in image processing devices such as cameras, smart phones, automobiles, and other image processing devices may be computing-intensive, requiring substantial computing resources to estimate motion between image frames in a series of image frames. The computing-intensive nature of motion estimation may limit the ability of devices with limited computing resources to perform such estimation and/or may consume substantial amounts of power in devices with limited battery capacities. An example process 300 for motion estimation in a series of frames is shown in FIG. 3. A sequence of frames may include an (N)th or current frame 302B, an (N−1)th or previous frame 302A, an (N+1)th or next frame 302C, and an (N+2)th or future frame 302D. A current frame being analyzed may be referred to as a target frame, and a frame immediately preceding the target frame in the series of frames may be referred to as a reference frame. Each pair of frames, such as each target frame and each prior, or reference, frame, in the series of frames may be processed together for motion estimation between the reference frame and the target frame.

As one example, a transform matrix may be generated, such as estimated, at 312 for the (N)th or current frame 302B. In order to generate the transform matrix at 312, several other parameters may be determined. For example, at 304 one or more correlation parameters for a reference frame, such as the prior, (N−1)th frame 302A, may be determined. Determination of correlation parameters for the reference frame 302A may include calculation of independent mean and variance parameters for the reference frame 302A. At 306, one or more correlation parameters for the target frame, such as the Nth frame 302B for which the transform matrix is being generated, may be determined. Determination of correlation parameters for the target frame may include calculation of independent mean and variance parameters for the target frame 302B. A cross correlation of the target frame 302B and the reference frame 302A may be determined using the reference frame correlation parameters determined at 304 and the target frame correlation parameters determined at 306. Determination of the cross-correlation at block 310 may include calculation of one or more cross-correlation parameters such as by calculating one or more normalized cross-correlation parameters. The cross-correlation parameters determined at block 310 may, for example, include one or more motion vectors from the target frame 302B to the reference frame 302A. Determination of the reference frame correlation parameters at 304, target frame correlation parameters at 306 and cross-correlation parameters at 310 may be referred to as a template mapping process.

In addition to template matching, object detection, such as corner detection, may also be performed at block 308 on the target frame 302B. In some cases, object detection may also be referred to as feature detection Object detection may include Harris Corner detection (HCD) and may include analysis of the target frame 302B to detect a position of one or more objects in the target frame 302B through edge detection. In some embodiments, in performing object detection, an image processor may select one or more edges or objects to track from frame to frame. For example, in performing object detection at block 308, one or more feature points corresponding to edges and/or objects in the frame 302B may be determined.

At block 312, a transform matrix for the target frame 302B may be generated, such as by estimating the transform matrix. The transform matrix may, for example, be generated using the cross correlation determined at block 310, such as one or more motion vectors, and the object detection data determined at block 308, such as one or more feature points determined using HCD. The transform matrix may, for example, indicate motion from the target frame 302B to the reference frame 302A. In some embodiments, the transform matrix may be a three by three transform matrix.

A similar process may be performed for next frame 302C. For example, one or more reference frame correlation parameters 314 may be determined for the previous target frame, now the new reference frame, frame 302B, one or more target frame correlation parameters 315 may be determined for the new target frame 302C, object detection may be performed at 316 on frame 302C, and a cross-correlation may be determined at 318 based on the reference frame correlation parameters determined at 314 and the target frame correlation parameters determined at block 315. A transform matrix for frame 302C may be generated at block 320, such as by estimating the transform matrix using the cross correlation determined at 318 and the object detection performed at block 316.

The transform matrix for frame 302C may, for example, indicate motion from frame 302C to frame 302B. Such calculations may be performed for previous frame 302A and future frame 302D as well. For example, the operations performed on frames 302B and 302C may be repeated for every set of two frames in a sequence of frames, apart from a first frame of the sequence of frames. Thus, according to the motion estimation process of FIG. 3, reference frame correlation and target frame correlation parameters may be calculated for each frame and object detection may be performed on each frame as well.

Computing resources required for motion detection may be reduced substantially by re-using correlation parameters calculated for a previous target frame as target frame correlation parameters for a subsequent target frame and reference frame correlation parameters calculated for a previous frame as reference frame correlation parameters for a subsequent frame. That is, target frame correlation parameters and reference frame correlation parameters may be calculated for alternating frames and reused in generation of transform matrices for subsequent frames. Computing power may be further reduced by performing object detection on only every other frame and re-using object detection data generated for a previous target frame in generating a transform matrix for a current target frame. Such reductions in computing resource usage may reduce power consumption. Furthermore, such re-use may reduce latency in image processing. For example, performing object detection on only every other frame may reduce object detection computing by 50%, and re-use of target frame correlation parameters or reference frame correlation parameters calculated for a previous frame to determine a transform matrix for a current frame immediately following the previous frame in a sequence of frames may reduce independent frame correlation parameter calculation by 50%. Such reductions in computing resource usage may result in power savings of up to and exceeding 20% over motion estimation performed according to the process of FIG. 3, with little to no negative impact on image quality.

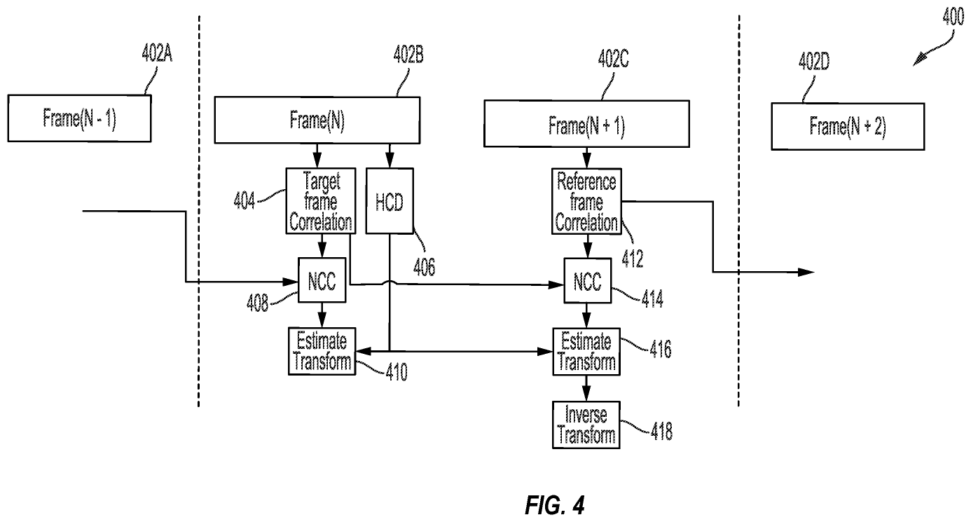

An example process 400 for efficient motion estimation in a series of frames is shown in FIG. 4. A sequence of frames may include an (N)th or current frame 402B, an (N−1)th or previous frame 402A, an (N+1)th or next frame 402C, and an (N+2)th or future frame 402D. Each pair of frames, such as each target frame and each, prior or reference, frame, in the series of frames may be processed together for motion estimation between a previous frame and a current frame. Motion estimation may include estimating a transform matrix for each frame in a series of frames, other than a first frame. In order to facilitate efficient motion estimation, target or reference frame correlation parameters determined for a previous target frame may be used as target or reference frame correlation parameters for a current target frame. Furthermore object detection may be performed on alternating frames, and object detection data from previous, or reference, frames may be re-used to generate transform matrices for target frames on which object detection is not performed.

For example, a first target frame 402B may be used to determine target frame correlation parameters at 404. Such determination may include calculation of independent mean and variance parameters, for the target frame 402B. A cross correlation of the target frame 402B and a reference frame 402A may be determined at block 408 using the target frame correlation parameters determined at 404 and reference frame correlation parameters determined earlier for frame 402A when generating a transform matrix for frame 402A. Thus, an image processor may refrain from determining reference frame correlation parameters for frame 402A for determination of a transform for frame 402B and instead may re-use reference frame correlation parameters previously determined during generation of a transform matrix for frame 402A. Determination of the cross-correlation at block 408 may include determination of one or more cross-correlation parameters such as by calculating one or more normalized cross-correlation parameters. The cross-correlation parameters determined at block 408 may, for example, include one or more motion vectors from the target frame 402B to the reference frame 402A. Determination of the target frame correlation parameters at 404 and cross-correlation parameters at 408 may be referred to as a template mapping process. Therefore, determination of target and reference frame correlation parameters may alternate from frame to frame.

In addition to template matching, object detection, such as corner detection, may also be performed at block 406 on the target frame 402B. Such corner detection may include Harris Corner detection (HCD) and may include analysis of the target frame 402B to detect a position of one or more objects in the target frame 402B through edge detection. In some embodiments, in performing object detection, an image processor may select one or more edges or objects to track from frame to frame. For example, in performing object detection at block 406, one or more feature points corresponding to edges and/or objects in the frame 402B may be determined.

At block 410, a transform matrix for the target frame 402B may be generated, such as by estimating the transform matrix. The transform matrix may, for example, be generated using the cross correlation determined at block 408, such as one or more motion vectors, and the object detection data determined at block 406, such as one or more feature points determined using HCD. The transform matrix may, for example, indicate motion from the target frame 402B to the reference frame 402A. In some embodiments, the transform matrix may be a three by three transform matrix. Thus, in generating a transform matrix for a first target frame, and other alternating target frames such as a future target frame 402D, determination of reference frame correlation parameters, such as performed at block 304 of FIG. 3, may be eliminated, enhancing efficiency of motion estimation calculation.

For determination of a transform matrix for next target frame 402C, previous frame 402B becomes a reference frame 402B. The next target frame 402C may be used to determine reference frame correlation parameters at 412. Such determination may include calculation of independent mean and variance parameters, for the target frame 402C. A cross correlation of the target frame 402C and a reference frame 402B may be determined at block 414 using the reference frame correlation parameters for frame 402C determined at 412 and target frame correlation parameters determined for frame 402B at block 404. Thus, the target frame correlation parameters determined at block 404 may be reused for determination of the cross correlation for frame 402C at block 414. In some embodiments, an image signal processor may track a number of each frame and may determine whether to determine reference frame correlation parameters or target frame correlation parameters for a current target frame depending on whether the current target frame is an even or odd numbered frame. Thus, an image processor may refrain from determining target frame correlation parameters for frame 402C for determination of a transform for frame 402C and instead may re-use target frame correlation parameters determined at block 404 used for generation of a transform for frame 402B. Determination of the cross-correlation at block 414 may include calculation of one or more cross-correlation parameters such as by calculating one or more normalized cross-correlation parameters. The cross-correlation parameters determined at block 414 may, for example, include one or more motion vectors from the reference frame 402B to the target frame 402C. Determination of the target reference frame correlation parameters at 412 and cross-correlation parameters at 414 may be referred to as a template mapping process.

An image signal processor may refrain from performing object detection, such as edge or corner detection, on frame 402C and may instead reuse object detection data generated for frame 402B at block 406. For example, an image signal processor may perform object detection on alternating frames, such as odd numbered frames or even numbered frames. Thus, the image signal processor may determine not to perform image signal processing on frame 402C based on frame 402C, for example, being an odd numbered frame of a sequence of frames when object detection is performed on even numbered frames of the sequence of frames.

At block 416, a transform matrix for the target frame 402C may be generated, such as by estimating the transform matrix. The transform matrix may, for example, be generated using the cross correlation determined at block 414, such as one or more motion vectors, and the object detection data determined at block 406, such as one or more feature points determined using HCD for the previous frame 402B. The transform matrix may, for example, indicate motion from the reference frame 402B to the target frame 402C. Thus, the transform matrix may be an inverse of a desired transform matrix indicating motion from the target frame 402C to the reference frame 402B due to use of the object detection data generated for frame 402B and the target frame correlation parameters calculated for frame 402B in generation of the transform matrix. An inverse transform may be performed on the transform generated at block 416 to produce a transform matrix in a desired direction for motion estimation, from the target frame 402C to the reference frame 402B. Generation of the inverse transform may require minimal computing overhead, such as substantially less computing overhead than generating target frame correlation and reference frame correlation parameters for determination of each transform matrix and performing object detection on each frame as described with respect to FIG. 3 would require. In some embodiments, the transform matrix may be a three by three transform matrix. Thus, in generating a transform matrix for the second target frame 402C, and other alternating target frames such as a future target frame 402D, determination of reference frame correlation parameters may be eliminated, enhancing efficiency of motion estimation calculation, reducing power consumption, and reducing latency.

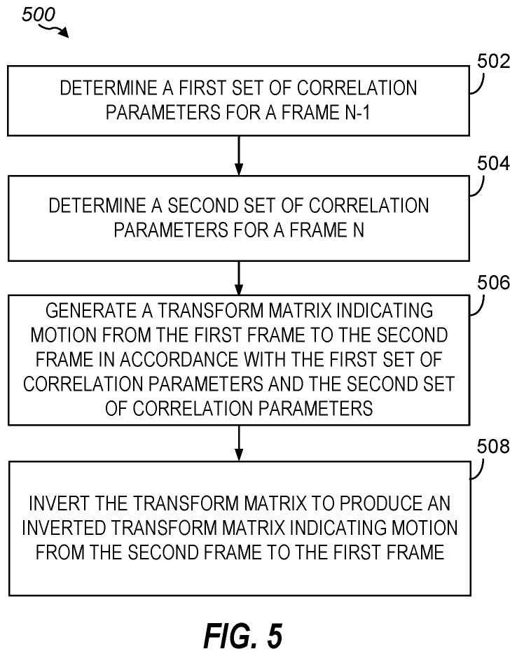

The system 200 of FIG. 2 may be configured to perform the operations described with reference to FIGS. 3-6 to determine output image frames 230. FIG. 5, for example, shows a flow chart 500 of an example method for processing image data to perform efficient motion estimation according to some embodiments of the disclosure. The efficient motion estimation in FIG. 5 may reduce computing power required for motion estimation, may result in longer battery life for device 100, and may reduce latency in image processing for device 100. Each of the operations described with reference to FIGS. 3-6 may be performed by one or a combination of the processor 104 (including cores 104A-N or AI engine 124) and/or the ISP 112.

At block 502, a first set of correlation parameters may be received for a first frame in a sequence of frames. For example, a first set of target frame correlation parameters or reference frame correlation parameters may be determined for the first frame. Such determination may, for example, include calculating independent mean and variance parameters for the first frame. In some embodiments, image data for the first frame may be received from an image sensor, and correlation parameters for the first frame may be calculated using the received image data. In some embodiments, for example, one of reference correlation or target correlation parameters may be determined for the first frame, while the other of reference correlation or target correlation parameters may not be determined for the first frame. For example, an image processing device may refrain from determining both reference frame correlation parameters for a previous frame and target frame correlation parameters for the first frame for use in generation of a transform matrix for the first frame.

At block 504, a second set of correlation parameters for a second frame of the sequence of frames may be determined. The second frame may, for example, be a frame immediately subsequent to the first frame in the sequence of frames. For example, a set of target frame correlation parameters for the second frame or a set of reference frame correlation parameters may be determined for the second frame. In some embodiments, for example, only one of target frame correlation parameters and reference frame correlation parameters may be determined for the first frame and the other of target frame correlation parameters and reference frame correlation parameters may be determined for the second frame. Such determination may, for example, include calculating independent mean and variance parameters for the second frame. In some embodiments, image data for the second frame may be received from an image sensor, and correlation parameters for the second frame may be calculated using the received image data. In some embodiments, for example, one of reference correlation or target correlation parameters may be determined for the second frame, while the other of reference correlation or target correlation parameters may not be determined for the second frame. For example, an image processing device may refrain from determining both reference frame correlation parameters for a previous frame and target frame correlation parameters for the second frame for use in generation of a transform matrix for the second frame. The first frame described with respect to FIG. 5 may, for example, correspond to the frame 402B of FIG. 4, and the second frame described with respect to FIG. 5 may correspond to the frame 402C of FIG. 4.

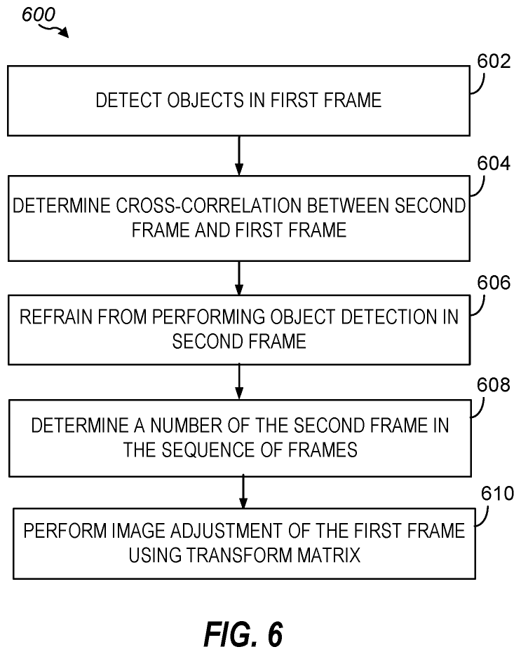

At block 506, a transform matrix indication motion from the first frame to the second frame may be generated in accordance with the first set of correlation parameters and the second set of correlation parameters. For example, a cross correlation from the first frame to the second frame may be determined in accordance with the first set of correlation parameters and the second set of correlation parameters. Determination of the cross correlation may, for example, include calculation of one or more normalized cross correlation parameters. For example, determination of the cross correlation may include calculation of one or more motion vectors indicating motion from the first frame to the second frame. A transform matrix may be generated in accordance with the cross correlation from the first frame to the second frame, such as based on the one or more normalized cross correlation parameters. The transform matrix may, for example, indicate motion from the first frame to the second frame. In some embodiments, the transform matrix may be a three by three transform matrix. In some embodiments, the transform matrix may be further generated in accordance with one or more objects detected in the first frame, such as based on object detection data as described with respect to block 602 of FIG. 6. However, for performing motion estimation a transform matrix indicating motion from the second frame to the first frame may be desired. For example, if the transform matrix is generated in accordance with correlation parameters from the first frame, correlation parameters from the second frame, and object detection data from object detection performed on the first frame, the transform matrix may indicate motion from the first frame to the second frame, rather than motion from the second frame to the first frame, when a transform matrix indicating motion from the second frame to the first frame may be useful for motion estimation.

At block 508, the transform matrix generated at block 506 may be inverted to produce an inverted transform matrix indicating motion from the second frame to the first frame. Inversion of the transform matrix may facilitate use of the transform matrix in performing motion estimation for image stabilization, temporal noise reduction, HDR, and other image adjustment techniques utilizing motion estimation. In some embodiments, an image processor may determine to invert the transform matrix based on a number of the frame in the sequence of frames. For example, the image processor may determine that object detection is only performed on even numbered frames of the sequence of frames, may determine that the second frame is an odd numbered frame, and may determine that inversion of the transform matrix should be performed on the generated transform matrix for the second frame in accordance with the second frame being an odd numbered frame. In some embodiments, one or more steps of the method 500 may be repeated for a third frame, such as a frame immediately following the second frame in a sequence of frames. For example, a third set of correlation parameters may be determined for the third frame in the sequence of frames. Furthermore, as the third frame is an even numbered frame, object detection may be performed on the third frame. A second transform matrix may be generated for the third frame indicating motion from the third frame to the second frame in accordance with the second set of correlation parameters determined for the second frame and the third set of correlation parameters determined for the third frame. The second transform matrix may, for example, not be inverted, as the second matrix may be generated for an even numbered frame indicating motion from the third frame to the second frame and using object detection data from object detection performed on the third frame. Thus, object detection may be performed on alternating frames of a sequence of frames and transform matrices may be inverted for frames on which object detection is not performed to generate inverted transform frames indicating motion from the target frame to the reference frame for each frame in the sequence other than a first frame in the sequence. In some embodiments, the method 500 may be repeated for successive frames in a sequence of frames.

FIG. 6, for example, shows a flow chart 600 of an example method for processing image data to perform efficient motion estimation according to some embodiments of the disclosure. The efficient motion estimation in FIG. 6 may reduce computing power required for motion estimation, may result in longer battery life for device 100, and may reduce latency in image processing for device 100. Each of the operations described with reference to FIGS. 3-6 may be performed by one or a combination of the processor 104 (including cores 104A-N or AI engine 124) and/or the ISP 112. In some embodiments, one or more blocks of the method of flow chart 600 may be performed along with one or more blocks of the method 500 or one or more blocks of FIG. 3 or 4. For example, one or more blocks of the method of flow chart 600 may be performed with respect to the first frame and second frame described with respect to FIG. 5.

At 602, one or more objects may be detected in the first frame. For example, object detection, as described herein, may be performed on the first frame described with respect to FIG. 5. Performing object detection may include determining object detection data, such as detecting one or more features in the first frame. For example, HCD may be performed on the first frame. The object detection data may be used in generating a transform matrix for the first frame as well as to generate a transform matrix for a second frame in a sequence of frames, such as described with respect to block 506 of FIG. 5. For example, block 602 may be performed prior to performing block 506 of FIG. 5. In some embodiments, object detection may be performed on alternating frames of a sequence of frames. For example, object detection may be performed on even-numbered frames of a sequence of frames and not on odd-numbered frames of a sequence of frames.

At 604, cross-correlation between the first frame and the second frame may be determined. For example, a cross correlation from the first frame to the second frame may be determined in accordance with the first set of correlation parameters determined at block 502 and the second set of correlation parameters determined at block 504. The cross correlation determined at 604 may be used in generating the transform matrix at block 506 of the method of FIG. 5. In some embodiments, determining the cross correlation between the first frame and the second frame may include determining one or more cross-correlation parameters, such as normalized cross correlation parameters, between the second frame and the first frame. Normalized cross correlation parameters between the first frame and the second frame may, for example, include motion vectors from the first frame to the second frame. The first frame described with respect to FIG. 6 may, for example, correspond to the frame 402B of FIG. 4, and the second frame described with respect to FIG. 5 may correspond to the frame 402C of FIG. 4.

At 606, an image processor may refrain from performing object detection in the second frame. For example, object detection, such as HCD, may be performed only on alternating frames in sequence of frames. Thus, because object detection is performed on the first frame, object detection may not be performed on the second frame. The object detection data generated during object detection of the first frame may thus be reused for generating a transform matrix for the second frame, as described with respect to block 506 of FIG. 5. In some embodiments, instead of refraining from performing object detection in the second frame, object detection may be performed in the second frame, but such object detection may be ignored in determining a transform matrix.

At 608, a number of the second frame in the sequence of frames may be determined. For example, an image processor may only perform object detection and/or invert a transform matrix for alternating frames of a sequence of frames. For example, object detection may be performed on even-numbered frames of a sequence of frames and inverting of a transform matrix may be performed for odd-numbered frames of a sequence of frames. Thus, for example, inverting the transform matrix at block 508 of FIG. 5 may be performed in accordance with a determination that the second frame is an odd-numbered frame of the sequence of frames.

At 610, image adjustment of the first frame may be performed using a transform matrix, such as the inverted transform matrix generated at block 508 of FIG. 5. For example, image stabilization, temporal noise reduction, HDR, or other image adjustment techniques may be applied to one or more frames using the inverted transform matrix generated at block 508 of FIG. 5. In some embodiments, one or more blocks of FIG. 6 may be repeated for successive image pairs.

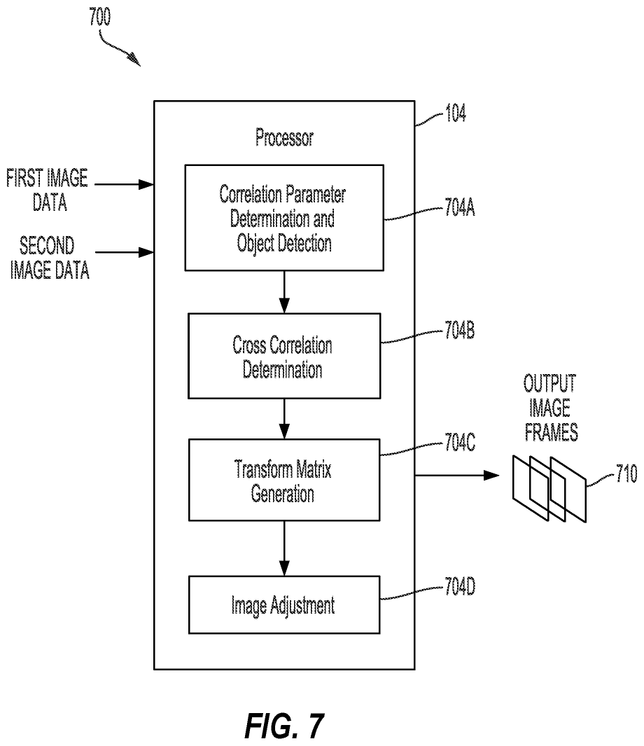

FIG. 7 is a block diagram illustrating an example processor configuration for image data processing in an image capture device according to one or more embodiments of the disclosure. The processor 104, or other processing circuitry, may be configured to operate on image data to perform one or more operations of the processes of FIGS. 3-4 and/or the methods of FIGS. 5-6. The image data may be processed to determine one or more output image frames 710.

The processor 104 receives first image data and second image data, such as first image data for a first frame in a sequence of frames and second image data for a second frame in the sequence of frames. In some embodiments, the first image data may be received directly from the image sensor or a memory coupled to the image sensor. In some embodiments, the first image data may be retrieved from long-term storage, such as flash storage device or network location, storing a picture that was previously captured or generated. Correlation parameter determination and object detection module 704A may perform object detection on one or both of the first image data and the second image data and may determine correlation parameters for one or both of the first image data and the second image data. Cross correlation determination module 704B may determine a cross correlation between a first frame of the first image data and a second frame of the second image data based on correlation parameters determined for the first image data and the second image data by module 704A. In some embodiments, cross correlation determination module 704B may determine a cross correlation between the first frame of the first image data and the second frame of the second image data and a cross correlation between the second frame of the second image data and the first frame of the first image data using a single set of correlation parameters determined for the first frame of the first image data and a single set of correlation parameters determined for the second frame of the second image data. Transform matrix generation module 704C may generate a transform matrix for the first frame of the first image data and the second frame of the second image data based on object detection data and cross correlation parameters determined, respectively, by modules 704B and 704A. Transform matrix generation module 704C may, for example, generate a transform matrix for a first frame of the first image data and a second frame of the second image data using only object detection data from object detection performed on one of the frames. In some embodiments, transform matrix generation module 704C may generate an inverted transform matrix by inverting a transform matrix that was generated for a frame on which object detection was not performed. Image adjustment module 704D may apply the transform matrices generated by transform matrix generation module 704C to perform motion estimation operations on one or more image frames, such as image stabilization, temporal noise reduction, HDR, or other motion estimation techniques.

One example operation of processor 104 is described with reference to FIG. 5. Another example operation of processor 104 is described with respect to FIG. 6. Still further example operations are described with respect to FIGS. 3-4.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to determine a first set of correlation parameters for a first frame of a sequence of frames, determine a second set of correlation parameters for a second frame of the sequence of frames, generate a transform matrix indicating motion from the first frame to the second frame in accordance with the first set of correlation parameters and the second set of correlation parameters, and invert the transform matrix to produce an inverted transform matrix indicating motion from the second frame to the first frame.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the apparatus is further configured to determine a cross-correlation from the first frame to the second frame, wherein generating the transform matrix is performed further in accordance with the cross-correlation.

In a third aspect, in combination with one or more of the first aspect or the second aspect, the apparatus is further configured to detecting one or more objects of the first frame, wherein the transform matrix is further generated in accordance with the detected one or more objects.

In a fourth aspect, in combination with one or more of the first aspect through the third aspect, detecting one or more objects of the first frame comprises performing corner detection on the first frame.

In a fifth aspect, in combination with one or more of the first aspect through the fourth aspect, determining the first set of correlation parameters comprises determining a first independent mean and a first independent variance of the first frame, and wherein determining the second set of correlation parameters comprises determining a second independent mean and a second independent variance of the second frame.

In a sixth aspect, in combination with one or more of the first aspect through the fifth aspect, the apparatus is further configured to determine a third set of correlation parameters for a third frame of the sequence of frames, detect one or more objects of the third frame, and generate a transform matrix indicating motion from the third frame to the second frame in accordance with the second set of correlation parameters and the third set of correlation parameters.

In a seventh aspect, in combination with one or more of the first aspect through the sixth aspect, the apparatus is further configured to refrain from performing object detection on the second frame.

In an eighth aspect, in combination with one or more of the first aspect through the seventh aspect, the apparatus is further configured to determine that the second frame is an odd-numbered frame of the sequence of frames, wherein inverting the transform matrix is performed in accordance with the determination that the second frame is an odd-numbered frame of the sequence of frames.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3-6 may be combined with one or more blocks (or operations) described with reference to another of the figures. For example, one or more blocks (or operations) of FIG. 5 may be combined with one or more blocks (or operations) of FIGS. 1-2. As another example, one or more blocks associated with FIG. 7 may be combined with one or more blocks (or operations) associated with FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for motion estimation, comprising:
determining a first set of correlation parameters for a first frame of a sequence of frames;
determining a second set of correlation parameters for a second frame of the sequence of frames;
generating a transform matrix indicating motion from the first frame to the second frame in accordance with the first set of correlation parameters and the second set of correlation parameters; and
inverting the transform matrix to produce an inverted transform matrix indicating motion from the second frame to the first frame.

2. The method of claim 1, further comprising:
determining a cross-correlation from the first frame to the second frame, wherein generating the transform matrix is performed further in accordance with the cross-correlation.

3. The method of claim 1, further comprising:
detecting one or more objects of the first frame,
wherein the transform matrix is further generated in accordance with the detected one or more objects.

4. The method of claim 3, wherein detecting one or more objects of the first frame comprises performing corner detection on the first frame.

5. The method of claim 1, wherein determining the first set of correlation parameters comprises determining a first independent mean and a first independent variance of the first frame, and wherein determining the second set of correlation parameters comprises determining a second independent mean and a second independent variance of the second frame.

6. The method of claim 1, further comprising:
determining a third set of correlation parameters for a third frame of the sequence of frames;
detecting one or more objects of the third frame; and
generating a transform matrix indicating motion from the third frame to the second frame in accordance with the second set of correlation parameters and the third set of correlation parameters.

7. The method of claim 1, further comprising:
refraining from performing object detection on the second frame.

8. The method of claim 1, further comprising:
determining that the second frame is an odd-numbered frame of the sequence of frames,
wherein inverting the transform matrix is performed in accordance with the determination that the second frame is an odd-numbered frame of the sequence of frames.

9. An apparatus, comprising:
a memory storing processor-readable code; and
at least one processor coupled to the memory, the at least one processor configured to execute the processor-readable code to cause the at least one processor to perform operations including:
determining a first set of correlation parameters for a first frame of a sequence of frames;
determining a second set of correlation parameters for a second frame of the sequence of frames;
generating a transform matrix indicating motion from the first frame to the second frame in accordance with the first set of correlation parameters and the second set of correlation parameters; and
inverting the transform matrix to produce an inverted transform matrix indicating motion from the second frame to the first frame.

10. The apparatus of claim 9, wherein the at least one processor is further configured to execute the processor-readable code to cause the at least one processor to perform operations including:
determining a cross-correlation from the first frame to the second frame, wherein generating the transform matrix is performed further in accordance with the cross-correlation.

11. The apparatus of claim 9, wherein the at least one processor is further configured to execute the processor-readable code to cause the at least one processor to perform operations including:
detecting one or more objects of the first frame,
wherein the transform matrix is further generated in accordance with the detected one or more objects.

12. The apparatus of claim 11, wherein detecting one or more objects of the first frame comprises performing corner detection on the first frame.

13. The apparatus of claim 9, wherein determining the first set of correlation parameters comprises determining a first independent mean and a first independent variance of the first frame, and wherein determining the second set of correlation parameters comprises determining a second independent mean and a second independent variance of the second frame.

14. The apparatus of claim 9, wherein the at least one processor is further configured to execute the processor-readable code to cause the at least one processor to perform operations including:
determining a third set of correlation parameters for a third frame of the sequence of frames;
detecting one or more objects of the third frame; and
generating a transform matrix indicating motion from the third frame to the second frame in accordance with the second set of correlation parameters and the third set of correlation parameters.

15. The apparatus of claim 9, wherein the at least one processor is further configured to execute the processor-readable code to cause the at least one processor to perform operations including:
refraining from performing object detection on the second frame.

16. The apparatus of claim 9, wherein the at least one processor is further configured to execute the processor-readable code to cause the at least one processor to perform operations including:
determining that the second frame is an odd-numbered frame of the sequence of frames,
wherein inverting the transform matrix is performed in accordance with the determination that the second frame is an odd-numbered frame of the sequence of frames.

17. A non-transitory computer-readable medium storing instructions that, when executed by a processor, cause the processor to perform operations comprising:
determining a first set of correlation parameters for a first frame of a sequence of frames;
determining a second set of correlation parameters for a second frame of the sequence of frames;
generating a transform matrix indicating motion from the first frame to the second frame in accordance with the first set of correlation parameters and the second set of correlation parameters; and
inverting the transform matrix to produce an inverted transform matrix indicating motion from the second frame to the first frame.

18. The non-transitory computer-readable medium of claim 17, further comprising instructions that, when executed by a processor, cause the processor to perform operations comprising:
determining a cross-correlation from the first frame to the second frame, wherein generating the transform matrix is performed further in accordance with the cross-correlation.

19. The non-transitory computer-readable medium of claim 17, further comprising instructions that, when executed by a processor, cause the processor to perform operations comprising:
detecting one or more objects of the first frame,
wherein the transform matrix is further generated in accordance with the detected one or more objects.

20. The non-transitory computer-readable medium of claim 19, wherein detecting one or more objects of the first frame comprises performing corner detection on the first frame.

21. The non-transitory computer-readable medium of claim 17, wherein determining the first set of correlation parameters comprises determining a first independent mean and a first independent variance of the first frame, and wherein determining the second set of correlation parameters comprises determining a second independent mean and a second independent variance of the second frame.

22. The non-transitory computer-readable medium of claim 17, further comprising instructions that, when executed by a processor, cause the processor to perform operations comprising:
refraining from performing object detection on the second frame.

23. The non-transitory computer-readable medium of claim 17, further comprising instructions that, when executed by a processor, cause the processor to perform operations comprising:
determining that the second frame is an odd-numbered frame of the sequence of frames,
wherein inverting the transform matrix is performed in accordance with the determination that the second frame is an odd-numbered frame of the sequence of frames.

24. An image capture device, comprising:
an image sensor;
a memory storing processor-readable code; and
at least one processor coupled to the memory and to the image sensor, the at least one processor configured to execute the processor-readable code to cause the at least one processor to:
detect a first set of correlation parameters for a first frame of a sequence of frames captured by the image sensor;
determine a second set of correlation parameters for a second frame of the sequence of frames;
generate a transform matrix indicating motion from the first frame to the second frame in accordance with the first set of correlation parameters and the second set of correlation parameters; and
invert the transform matrix to produce an inverted transform matrix indicating motion from the second frame to the first frame.

25. The image capture device of claim 24, wherein the at least one processor is further configured to execute the processor-readable code to cause the at least one processor to:
determine a cross-correlation from the first frame to the second frame, wherein generating the transform matrix is performed further in accordance with the cross-correlation.

26. The image capture device of claim 24, wherein the at least one processor is further configured to execute the processor-readable code to cause the at least one processor to:
detect one or more objects of the first frame,
wherein the at least one processor is further configured to execute the processor-readable code to cause the at least one processor to generate the transform matrix further in accordance with the detected one or more objects.

27. The image capture device of claim 26, wherein to detect one or more objects of the first frame the at least one processor is further configured to execute the processor-readable code to cause the at least one processor to perform corner detection on the first frame.

28. The image capture device of claim 24, wherein to determine the first set of correlation parameters the at least one processor is further configured to execute the processor readable code to cause the at least one processor to determine a first independent mean and a first independent variance of the first frame, and wherein to determine the second set of correlation parameters the at least one processor is further configured to execute the processor-readable code to cause the at least one processor to determine a second independent mean and a second independent variance of the second frame.

29. The image capture device of claim 24, wherein the at least one processor is further configured to execute the processor-readable code to cause the at least one processor to:
refrain from performing object detection on the second frame.

30. The image capture device of claim 24, wherein the at least one processor is further configured to execute the processor readable code to cause the at least one processor to:
determine that the second frame is an odd-numbered frame of the sequence of frames,
wherein the at least one processor is further configured to execute the processor readable code to cause the at least one processor to invert the transform matrix in accordance with the determination that the second frame is an odd-numbered frame of the sequence of frames.
